(19) United States
(12) Patent Application Publication
(10) Pub. No.: US 2006/0101176 A1
(43) Pub. Date: May 11, 2006

(54) Card type personal computer

(75) Inventors: Oh-Yang Eric, Hsinchu (TW); Tasi Yu-Chih, Hsinchu (TW)

Correspondence Address: TRANSPACIFIC LAW GROUP, 617 NORTH DELAWARE STREET, SAN MATEO, CA, 94401, US

(73) Assignee: Abocom Systems, Inc.

(21) Appl. No.: 10/985,357

(22) Filed: Nov. 10, 2004

(51) Int. Cl. G06F 13/38; G06F 13/12

(52) U.S. Cl. 710/62

(57) ABSTRACT

The present invention discloses a card type personal computer, comprising: a card-shaped substrate and, provided on said card-shaped substrate, interface connectors, interface controller, central processing unit, memory, power supply and extension slots. The interface connector may be plugged into corresponding interface slots of an external computer or an electronic device with a displaying device. The interface controller controls the operation such as communication, surfing and data exchange between the invented card type PC and the external computer or the electronic device and obtains working power from the external computer or the electronic device. The card type PC of this invention may further comprise a wireless communication module to communicate with external devices.

### FIELD OF THE INVENTION

The present invention relates to a new computer architecture, especially to a card type person computer.

### BACKGROUND OF THE INVENTION

The personal computer (PC) has become necessary equipment for everyone's daily life. Personal computers made in the portable style, such as notebook type PC, personal digital aid, mobile computer etc., have been treated as living or professional tools for most people.

For those who need to use the PC in most hours of the day, even the most advanced computer is too bulky to carry. While, along with the rapid development of technology, all kinds of peripheral are down-sized day by day, the input and output devices of the PC, especially the keyboard and the display, maintained their traditional sizes. This is because the size of keyboard and the display has its functional limitations. For example, a display is used to display information, allowing the user to read. Size of the display may not shrink to such level that users are not able to observe the information being displayed. As to the keyboard, its functions include allowing users to key in information in an efficient manner. No one will design a keyboard that is small but at the same time brings difficulties to users in inputting data into the PC. Although external keyboard or touch keyboard are proved commercially feasible, that the size of PC is limited to the size of display, however, is an unchanged fact.

In addition, power supply for PC also becomes a limitation in the design of PC. The space and weight of the battery and the converter used in most PC's have been the major factors for the dimension and the weight of the PC. For most PC's, its dimension is determined by the dimension of its battery and its weight is determined by the weight of its battery. For some other PC's, weight of its converter could be heavier than that of the PC itself.

It is thus necessary to provide a new PC architecture, wherein the size of the computer is not limited by its display device and keyboard, and its weight is not determined by the weight of its peripherals such as battery.

### OBJECTIVES OF THE INVENTION

The objective of this invention is to provide a card type personal computer.

Another objective of this invention is to provide a personal computer where no particular displaying device is needed.

Another objective of this invention is to provide a personal computer where no particular power supply device is needed.

Another objective of this invention is to provide a personal computer with very small size, dimension and lightweight, without bringing substantial limitations to its functionality.

### SUMMARY OF THE INVENTION

According to the present invention, a card type PC is provided. The card type personal computer comprises: a card-shaped substrate and, provided on said card-shaped substrate, interface connectors, interface controller, central processing unit, memory, power supply and extension slots. The interface connector may be plugged into the compatible interface slots of an external computer or an electronic device that is equipped with a displaying device. The interface controller controls the operation such as communication, surfing and data exchange between the invented card type PC and the external computer or the electronic device and obtains working power from the external computer or the electronic device. The central processing unit has the same operating and calculating capabilities as that of an ordinary personal computer. The memory provides memory space for temporary storage of data being processed by the central processing unit and for storage of user data. The power supply provides working power for the card type PC during its operation or sleeping period and is rechargeable. The extensional slot receives the connection of compatible interface connectors that is connected to a computer device, communication device, peripheral or electronic device. The card type PC of this invention may further comprise a wireless communication module provided on the substrate to communicate with external devices through applicable communication protocols.

These and other objectives and advantages of this invention may be clearly understood from the detailed description by referring to the following drawing.

### BRIEF DESCRIPTION OF THE DRAWINGS

FIG. 1 shows the system diagram of the card type personal computer of this invention.

### DETAILED DESCRIPTION OF THE INVENTION

The card type PC of this invention will be described by illustrating its embodiments. The purpose of the embodiment is to illustrate the present invention without limiting the scope of this invention.

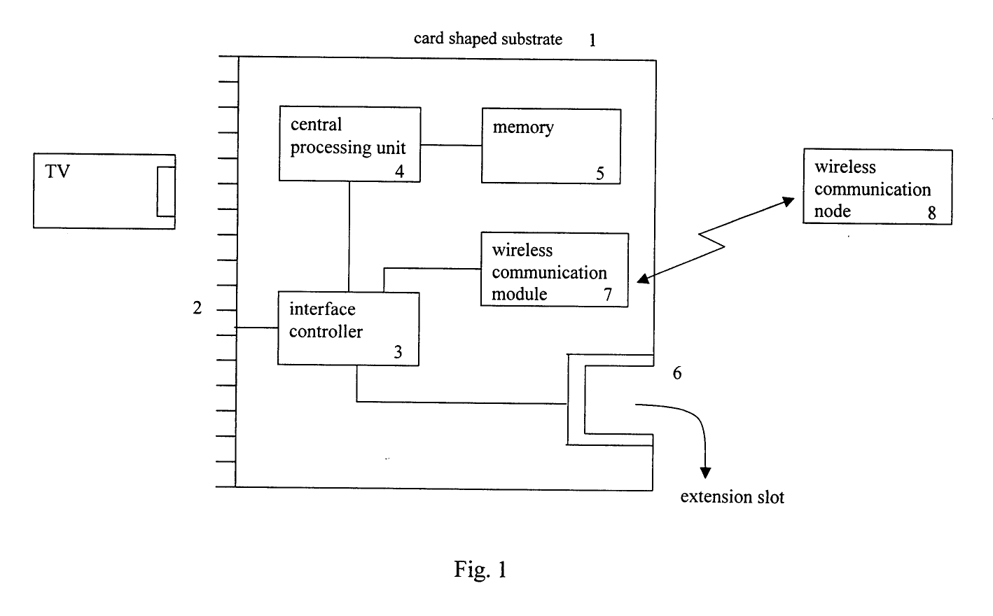

FIG. 1 shows the system diagram of the card type personal computer (PC) of this invention. As shown in this figure, the card type PC of this invention comprises as its main structure: a card shaped substrate 1 and an upper cover and a lower cover (both not shown) enclosing the card-shaped substrate 1. The size and shape of the card shaped substrate 1 are not limited to any particular size and shape. Preferably, the substrate 1 may be a thin plate or a thin plate with thicker portions. The outer peripheral of the substrate may be rectangular, ellipse, polygon, irregular shape or any other applicable appearance. As to its size, it may be the size of a memory card, or any size smaller or larger than that, as long as it does not influence its application or become hazardous when inserted into the slot of the external computer or the electronic devices.

The card type PC as shown in this figure has an interface connector 2, a multiple-function interface controller 3, central processing unit 4, memory 5, power supply 6 and extension slot 7.

The interface connector 2 is provided at one end of said card-shaped substrate 1 and may be plugged into interface slots provided in an external computer or electronic device with the same protocol, so that the card type PC may be connected to the external computer or the electronic device (both not shown). There is no particular requirement in respect to the specifications or functionality of the external computer or the electronic device. However, a basic requirement for the external computer or the electronic device is that they need to be provided with a displaying device. Another requirement is that the external computer or the electronic device shall have an interface slot that is compatible to the interface connector 2, so that data exchange and power supply may be conducted via, in combination, the interface connector 2 and the interface slot of the external computer or the electronic device. Applicable interface standards include: PCMCIA, USB, PS2, PCI, CARDBUS etc. The structure and shape of the interface connector 2 may be determined by the interface slot. As to number of the interface connector being provided in the card type PC, there is no particular requirement in this invention.

The interface controller 3 is used to control the data exchange between the card type PC and the external computer or the electronic device and to obtain necessary working power from the external computer or the electronic device. As a result, the interface controller 2 shall be equipped with control capability such that, under certain interface standards, data exchange may be effectively preceded. Controllers provided with such data exchange-control capabilities, or their IP's, are commercially available in the market. In addition, an experienced engineer may also accomplish such a controller with similar control functions based on a general-purposed microcontroller by adding specially designed hardware or software to the microcontroller.

Nevertheless, the interface controller is provided with capability of obtaining working voltage from the external computer or the electronic device. Under such requirement, the interface slot of the external computer or the electronic device shall have at least two connection pins that may supply a stable voltage. Using the connecting pins of the communication interface connector as source of working power has been a known technology and is used in most peripheral devices. Those skilled in the art may realize such a circuit based on the know technology. Detailed description thereof is thus omitted.

The central processing unit (CPU) 4 is the most important device in a personal computer. The central processing unit 4 processes all kinds of data, calculation, data exchange, control etc. There are a variety of commercially available CPU products that can provide the functionalities required in the card type PC of this invention. However, the dimension of the CPU is preferably slim so that it may be made a card shape. Power consumption and heat generation of the CPU are also important factors in the selection of applicable CPU products to be used as CPU 4 of the invention. Types of CPU that can be used in the card type PC include: Pentium, Celeron, Athlon and Druon. In addition, it is possible to use applicable CPU IP's to design a CPU circuit that is in particular applicable to the card type PC of this invention.

The function of memory 5 is to provide a space to temporarily store data to be processed or exchanged by or between the card type PC of this invention. It also serves to store system programs and application programs to be used in the invented card type PC. Data generated or created by the user using the card type PC or other devices may also be stored in this memory 5. Although it is preferable that the memory will not dramatically increase the production cost of the card type PC, will not occupy too much space of the card type PC and will not generate too much thermal energy, there are no particular limitations to the type and specification of the memory device 5.

In one embodiment of this invention, application software to be used in the card type PC is store in a remote computer. The card type PC downloads the application software through a local network or the internet. In such a case, the card type PC may be equipped with a wireless communication module 7, to connect to a wireless access point in order to access the application software that is stored in the remote computer of a local network system or the internet. (To be described in details hereinafter.)

If a plurality of application software is not stored in the card type PC, the memory space of the memory 5 may be reduced. In addition, it is possible to use a small-scaled hard disc drive or similar disc drive as virtual memory.

The extensional slot 6 serves as data exchange channel between the card type PC and external devices. The extensional slot 6 may have a plurality of connecting pins and complies with an industrial standard or a particularly specified interface protocol. The interface protocol may be the same as or different from that of the interface connector 2. Number of the applicable interface standard is not limited to one. Applicable interface standards for the extensional slot 6 include: PCMCIA, USB, PS2, PCI, CARDBUS etc. Other industrial or special standards or protocols may also be used in this invention. The extensional slot 6 may be used to connect another computer, a peripheral such as a display, a printer, a communication card, a memory card, a mouse, a keyboard, a camera, a video recorder, an optical disc drive, a magnetic disc drive, a projector, an earphone, a speaker (or amplifier), a microphone, or any other external equipments provided with interface connectors compatible to that of the extensional slot 6. The control of the extensional slot 6 may be conducted by the interface controller 3, such that the operational efficiency of the card type PC may be further enhanced.

Due to the mobile network communication application has become a necessary function of the computer system, the card type PC of this invention provides an optional wireless communication module 7 to satisfy the need of mobile network communication of the user. The wireless communication module 7 may be used to dynamically connect to a local network system (not shown) to access data stored in other computers through the network or to utilize the peripheral devices connected thereto. The wireless communication module 7 may further provide internet surfing functions allowing users to surf in the internet, in order to access the large quantity of data and information distributed in the internet, and to conduct network communications. In the above embodiment of this invention, the wireless communication module 7 preferably provides a billing system to authorize and to calculate expenses arising from use of the external application software. The wireless communication module 7 may be realized by using any commercially available product or technology. Details of such products or technologies are thus omitted. Data or signals being transmitted or received by the wireless communication module 7 may be processed by the interface controller 3, so that efficient data processing may be achieved.

The personal computer as described above may be prepared in the size as a memory card. The card type PC of this invention is thus easy to carry. Its dimension is not limited by any other devices, such as the keyboard or the display. When a user uses the card type PC of this invention, the card type PC is inserted into the memory card slot of an external computer or an electronic device, such as a television set. Communications between the card type PC and the external computer or device is initialized and, thus, the card type PC can utilize the display device of the external computer or the electronic device as its visual output device. Interactive operation with user may also be conducted through such displaying interface, using a keyboard or a mouse, or even the remote controller of the electronic device. It is also possible to connect further keyboard, mouse etc. via the extensional slot 6. When the invented card type PC is in use, the firewall technology may be used to prevent access of the CPU 4 or memory 5 of the card type PC from outside, such that high level safety and privacy protection may be realized. When the user stops using this card type PC, the card is removed from the external computer or the electronic device and may be carried to anywhere. Files and information as stored in the memory 5 may be downloaded to any designated memory device or computer equipment via the extensional slot 6. In addition, the extensional slot 6 or the wireless communication module 7 may also function as communication channel between this card type PC and any external devices.

The card type PC of this invention may be prepared in a size identical to that of a network card, or a memory card. It, however, is able to provide sufficient functions that are expected to be provided by an ordinary personal computer. The size, dimension, shape and weight of the card type PC are not limited by any other device, which are typical limitations to traditional PC's.

As the present invention has been shown and described with reference to preferred embodiments thereof, those skilled in the art will recognize that the above and other changes may be made therein without departing form the spirit and scope of the invention.

What is claimed is:

1. A card type personal computer (PC) comprising a card-shaped substrate and provided thereon:
a communication interface connector to be inserted to compatible communication interface slot provided in an external computer or an electronic device provided with a display device;
at least one communication interface controller to control data exchange between said card type PC and said external computer or electronic device and to obtain working power for said card type PC from said external computer or electronic device;
at least one central processing unit to provide operation or calculation capabilities;
at least one memory to provide temporary storage spaces for computer programs and data to be processed by said central processing unit and data of user files; and
at least one extensional slot to allow insertion by compatible interface connector of computer equipments, communications equipments or electronic devices.

2. The card type PC according to claim 1, further comprising a power supply provided on said card shaped substrate to supply power to said PC during a term of stand-by mode.

3. The card type PC according to claim 2, wherein said power supply is rechargeable.

4. The card type PC according to claim 1, further comprising a wireless communication module to connect a local network system in order to access data in other computers connected to said network system or to utilize peripherals connected to said network system.

5. The card type PC according to claim 4, wherein said wireless communication module further provides an internet connecting function to connect said card type PC to the internet.

6. The card type PC according to claim 1, wherein said communications interface connector is a PCMCIA connector.

7. The card type PC according to claim 1, wherein said communications interface connector is a USB connector.

8. The card type PC according to claim 1, wherein said communications interface connector is a CardBus connector.

9. The card type PC according to claim 1, wherein said communications interface connector is a PCI connector.

10. The card type PC according to claim 1, wherein said at least one extensional slot is a PCMCIA slot.

11. The card type PC according to claim 1, wherein said at least one extensional slot is a USB slot.

12. The card type PC according to claim 1, wherein said at least one extensional slot is a CardBus slot.

13. The card type PC according to claim 1, wherein said at least one extensional slot is a PCI slot.
